(19) United States
(12) Patent Application Publication
(10) Pub. No.: US 2003/0085797 A1
(43) Pub. Date: May 8, 2003

(54) System and method for determining the authenticity of a product

(76) Inventor: Hongbiao Li, Plano, TX (US)

Correspondence Address: Michael L. Diaz, Michael L. Diaz, P.C., 555 Republic Drive, Suite 200, Plano, TX, 75074, US

(21) Appl. No.: 10/091,735

(22) Filed: Mar. 6, 2002

Related U.S. Application Data
(63) Continuation-in-part of application No. 09/992,369, filed on Nov. 6, 2001.

(51) Int. Cl. G06F 7/04

(52) U.S. Cl. 340/5.8; 340/5.86

(57) ABSTRACT

A method and system for determining the authenticity of a product. The system includes an authenticating agency having a database with stored valid product codes. A product is affixed with an authentication tag having an identification number and a product code. The product code is concealed by a removable strip. A consumer purchases the product and removes the strip to reveal the product code. The consumer communicates with the authenticating agency and conveys the identification number and product code to the authenticating agency. The authenticating agency retrieves the valid product code associated with the identification number and compares it with the product code submitted by the consumer. If the codes match, the product is authenticated by the authenticating agency. The authenticating agency then communicates the results of the determination to the consumer.

### RELATED APPLICATIONS

This application is a continuation-in-part of a co-pending U.S. patent application (Ser. No. 09/992,369, Attorney Docket No. 5011-0005) entitled “System and Method for Authentication Products,” filed Nov. 6, 2001 in the name of Hongbiao Li, which is hereby incorporated in its entirety by reference herein.

### BACKGROUND OF THE INVENTION

1. Technical Field of the Invention

This invention relates to product authentication systems and, more particularly, to a system and method for determining the authenticity of a product.

2. Description of Related Art

The counterfeit of name brand products has become a serious problem in the current global marketplace. It is quite common for “knock-offs” of name brand products to enter the marketplace. These forged products are often difficult to distinguish from authentic name brand products. A significant amount of revenue is lost each year to the manufacture and sale of these counterfeited products.

Co-pending U.S. patent application Ser. No. 09/992,369 ('369) describes a system for authenticating products. However, '369 requires the use of an interface device at the point of sale of the product. Specific hardware and system components, which may be costly and cumbersome for the user, are required to determine the authenticity of a product.

Thus, it would be a distinct advantage to have a system and method which enables a consumer, without utilizing additional hardware, to authenticate a specified product. It is an object of the present invention to provide such a system and method.

### SUMMARY OF THE INVENTION

In one aspect, the present invention is an authenticating system for determining the authenticity of a product. The system includes an authenticating agency storing an authentication code, a product having an authentication tag. The authentication tag includes a product code. The consumer communicates the product code to the authenticating agency. The consumer communicates the product code to the authenticating agency. The authenticating agency determines if the product code matches the authentication code to indicate the authenticity of the product.

In another embodiment, the present invention is a method of determining an authenticity of a product. The method begins by programming an authenticating agency with a valid authenticating code. An authentication tag is then affixed to a product. The authentication tag includes a product code. Next, a consumer purchases the product. The product code is then provided to the authenticating agency. Next, the authenticating agency determines if the product code matches the authenticating code and provides a result of a match of the product code with the authenticating code.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 is a simplified block diagram illustrating the components of a system for authenticating the origin of goods from a specific manufacturer in the preferred embodiment of the present invention;

FIG. 2 is an enlarged front view of the authentication tag in the preferred embodiment of the present invention;

FIG. 3 is an enlarged front view of the authentication tag of FIG. 2 with the concealing strip removed; and

FIGS. 4A and 4B are flow charts outlining the steps for authenticating a product according to the teachings of the present invention.

### DETAILED DESCRIPTION OF EMBODIMENTS

The present invention is a system and method for authenticating the origin of goods from a specific manufacturer.

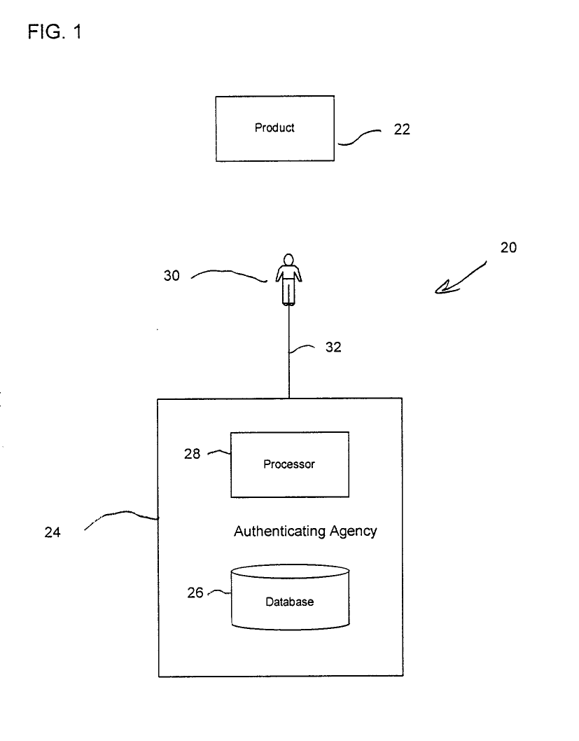

FIG. 1 is a simplified block diagram illustrating the components of a system 20 for authenticating the origin of goods from a specific manufacturer in the preferred embodiment of the present invention. The system includes a product 22 having an authentication tag 24 affixed to the product or its packaging. In addition, the system includes an authenticating agency 24. The authenticating agency includes a database 26 and a processor 28. A consumer 30 may communicate with the authenticating agency 24 by communicating through a link 32.

The database 26 is located within the authenticating agency 24 and provides information correlating a specific product with one or more valid authenticating codes. The database may be a lookup table having the title of the product or an identification code, such as a “SKU” number associated with one or more codes. The codes may be numbers, letters, colors, or any identifying piece of data used to distinguish the product. In the preferred embodiment of the present invention, the authenticating codes are stored within a secured database and remain confidential.

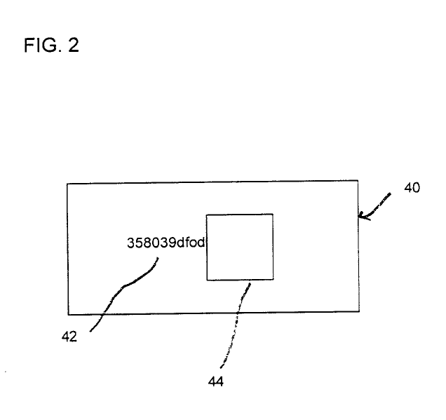

FIG. 2 is an enlarged front view of the authentication tag 40 in the preferred embodiment of the present invention. The product 22 is affixed with the authentication tag 40 in any manner allowing the consumer to see the tag. The tag may be affixed to the product directly or packaging of the product. The tag may also be permanently affixed to the product, such as by engraving the information directly to the product. The authentication tag includes a visible product identification number 42. The identification number serves to identify the product during the authentication process. The identification number may be any indicator allowing the identification of the product, such as numbers, symbols, letters, or a bar code. The identification number may also provide a classification scheme to classify the products. For example, the identification number may begin with a “2,” which may indicate that the product belongs to an apparel class. The next number may be a “3,” indicating that the product is a shirt. A concealing strip 44 is also located on the authentication tag 40.

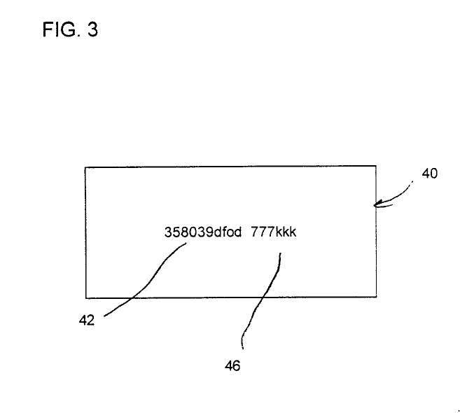

FIG. 3 is an enlarged front view of the authentication tag 40 of FIG. 2 with the concealing strip 44 removed. The concealing strip is easily removable. With the concealing strip removed, a product code 46 is visible. Although a concealing strip is utilized in FIGS. 2 and 3, any device may be used to hide the product code from view. For example, a “scratch off” area may be used to reveal the code. It should be understood, that any device which conceals the code from view, yet can be removed to reveal the code by a consumer, may be utilized.

With reference to FIGS. 1-3, the operation of the system 20 will now be explained. The authentication tag 40 is affixed to the product 22 or its packaging. Prior to purchase by the consumer 30, the concealing strip 44 hides the product code 46 from view. The authenticating agency 24 includes a database 26 which stores a identification code and matching product code or codes. In the preferred embodiment of the present invention, each product has a plurality of product codes available. Thus, a wide range of codes may be successfully used, preferably allocating only one code for each product manufactured.

When the consumer 30 purchases the product 22, the authentication tag 40 is examined. The consumer may then remove the concealing strip 44 to reveal the product code 46. The consumer then communicates with the authenticating agency, such as through the Internet or by telephone. The authentication tag may include a telephone number or website address to direct the consumer to the authenticating agency. The consumer provides the authenticating agency with the identification number 42 and the product code 46. The authenticating agency then finds the identification number identifying the particular product from the database 26 and retrieves the proper product code. The processor 28 determines if the product code 46 received from the consumer matches the proper product code stored in the database. If the codes do not match, the authenticating agency sends a negative response to the consumer. However, if the codes match, the authenticating agency informs the consumer that the product is authentic. The authenticating agency may optionally remove the product code from the database, thus preventing a counterfeiter from using that number to circumvent the authentication system 20.

By utilizing the system 20, a manufacturer of a product provides a consumer a simple procedure for determining if the product the consumer purchased is authentic. Without the proper product code, which is held securely within the database 26, a counterfeiting manufacturer cannot duplicate the code without buying the product. In addition, once the code has been used and processed through the authenticating agency 24, it may be removed as a valid product code from the database. Thus, the code is useable only one time, preventing the unauthorized use of the product code.

In an alternate embodiment of the present invention, the authentication tag 40 may include only a code 46 without an identification number 42. In such a system, the consumer merely communicates with the authenticating agency 24 and provides one code, the product code. The authenticating agency then determines if the code is an authentic code.

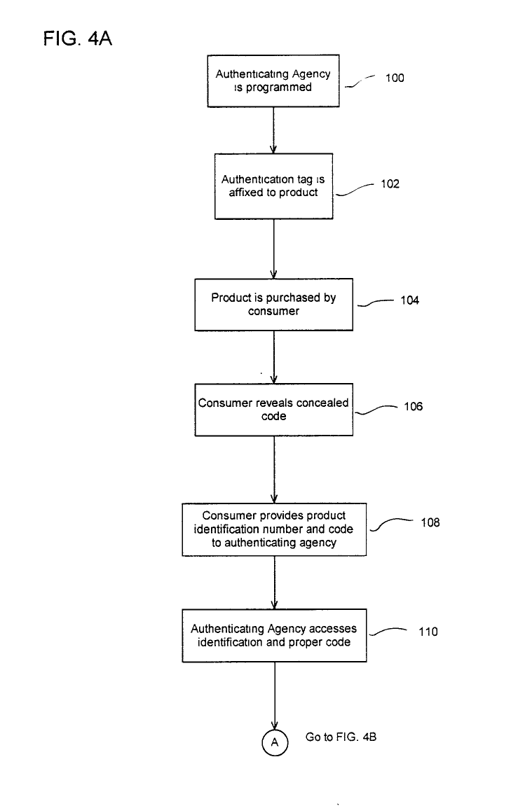

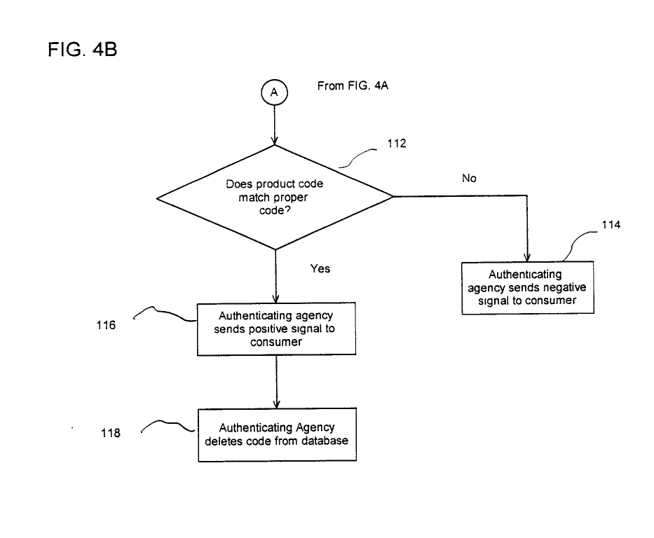

FIGS. 4A and 4B are flow charts outlining the steps for authenticating a product 22 according to the teachings of the present invention. With reference to FIGS. 1, 2, 3, 4A, and 4B, the steps of the method will now be explained. The method begins with step 100 where the authenticating agency is programmed with at least one product identification number 42 aligned with the product 22 and a valid product code 46. In the preferred embodiment of the present invention, each product identification number has a plurality of valid product codes. Preferably, there are distinct product codes available for each product manufactured. Next, in step 102, the authentication tag 40 is affixed to the product 22 or its packaging. The authentication tag includes a visible product identification number 42 and a concealed product code 46, preferably hidden by the removable concealing strip 44. In step 104, the product is purchased by the consumer 30.

The method then moves to step 106 where the consumer 30 reveals the concealed product code 46 by removing the concealing strip 44. Next, in step 108, the consumer communicates with the authenticating agency 24 and provides the agency with the identification number 42 and the product code 46 of the purchased product 22. In step 110, the authenticating agency accesses the proper product code or codes from the database 26. Next, in step 112, it is determined if the product code provided by the consumer matches the proper code retrieved from the database. If it is determined that the provided product code and the retrieved code do not match, the method moves to step 114 where the authenticating agency optionally sends a negative response to the consumer 30 indicating that the product is not authentic.

However, if it is determined that the provided code 46 and the retrieved code from the database 26 match, the method moves from step 112 to step 116 where the authenticating agency sends a positive signal to the consumer indicating that the product is authentic. The positive signal may be through any form of communication, such as verbally, through an email, a specific tone or code to indicate that the product is authentic. Next, in step 118, the authenticating agency optionally deletes the used product code from the database. Thus, the code can only be used once, to prevent usage by a counterfeiting manufacturer.

The disclosed system and method provide an effective and simple procedure for consumers to determine if the products they purchased are authentic. The disclosed invention, unlike existing authenticating systems, does not require specialized tools to determine the authenticity of the product. A consumer merely communicates a code and identification number to the authenticating agency. The authenticating agency can then determine if the code is proper. Additionally, since the code is preferably only useable once, the authentication tag cannot be duplicated.

It is thus believed that the operation and construction of the present invention will be apparent from the foregoing description. While the method and system shown and described have been characterized as being preferred, it will be readily apparent that various changes and modifications could be made therein without departing from the scope of the invention as defined in the following claims.

What is claimed is:

1. An authenticating system for determining the authenticity of a product, said system comprising:
an authenticating agency storing an authentication code;
a product having an authentication tag, said tag having a product code; and
means for communicating by a consumer purchasing said product to said authenticating agency;
whereby the consumer communicates the product code to said authenticating agency, said authenticating agency determining if the product code matches the authentication code to indicate the authenticity of said product.

2. The authenticating system of claim 1 wherein the authentication tag includes an identification number for the product associated with the authentication code;
whereby the consumer communicates both the identification number and the product code to said authenticating agency, said authenticating agency using the identification number to match the product code with the authentication code for the product.

3. The authenticating system of claim 1 wherein the authentication tag includes a removable strip concealing the product code;
whereby the consumer removes the removable strip to reveal the product code.

4. The authenticating system of claim 1 wherein the authenticating agency includes a database having a plurality of authentication codes matched to a plurality of identification numbers, at least one identification number associated with the product.

5. The authenticating system of claim 4 wherein each authentication code may only be utilized once for authenticating said product.

6. The authenticating system of claim 1 wherein said authenticating agency provides a response indicator to the consumer to indicate if said product is authentic.

7. A method of determining an authenticity of a product, said method comprising the steps of:
programming an authenticating agency with a valid authenticating code;
affixing an authentication tag to a product, the authentication tag having a product code;
purchasing, by a consumer, the product;
providing the product code to the authenticating agency;
determining, by the authenticating agency, if the product code matches the authenticating code; and
providing the consumer a result of a match of the product code with the authenticating code.

8. The method of determining an authenticity of a product of claim 7 wherein the authentication tag includes an identification number used in associating the product with the authentication code.

9. The method of determining an authenticity of a product of claim 8 wherein:
the product code is hidden prior to purchase; and
further comprising, before the step of providing the product code to the authenticating agency, the step of revealing the product code by the consumer.

10. The method of determining an authenticity of a product of claim 9 wherein the product code is hidden by positioning a removable strip over the product code.

11. An authenticating system for determining the authenticity of a product, said system comprising:
an authenticating agency storing an authentication code;
a product having an authentication tag, said tag having a product code and an identification number for identifying the product; and
means for communicating by a consumer purchasing said product to said authenticating agency;
whereby the consumer communicates both the identification number and the product code to said authenticating agency, said authenticating agency using the identification number to identify the authentication code and determining if the product code matches the authentication code for the product, said authenticating agency providing a result of the match of the authentication code with the product code to the consumer.
